(19) United States
(12) Patent Application Publication
(10) Pub. No.: US 2011/0047021 A1
(43) Pub. Date: Feb. 24, 2011

(54) Minimum and maximum recommended supply lines for determining price-protection rebate

(76) Inventors: Mamnoon Jamil, voorhees, NJ (US); Markus Ettl, Ossinging, NY (US); Blair Binney, Hopewell Junction, NY (US); Donnie D. Haye, Chapel Hill, NC (US); Benjamin T. Massie, Raleigh, NC (US); William S. Maton, Wake Forest, NC (US); Karthik Sourirajan, White Plains, NY (US)

Correspondence Address: Law Offices (Austin), 1230 E Baseline Rd #103-248, Mesa, AZ, 85204, US

(21) Appl. No.: 12/545,013

(22) Filed: Aug. 20, 2009

(51) Int. Cl. G06Q 30/00; G06Q 50/00; G06Q 10/00; G06Q 20/00

(52) U.S. Cl. 705/14.34; 705/28

(57) ABSTRACT

A minimum recommended supply line (RSL) and a maximum RSL during a time period are determined. The minimum RSL is based on a minimum number of a product that is recommended to be in inventory for the time period. The maximum RSL is based on a maximum number of the product that is recommended to be in inventory for the time period. A number of the product is purchased equal to or greater than the minimum RSL minus a number of the product already in inventory at a beginning of the time period. A price-protected number of the product is determined as a smaller of the maximum RSL and a number of the product in inventory at an end of the time period. A rebate amount is determined as equal to the price-protected number multiplied by a decrease in price of the product from the time period to a next time period.

### BACKGROUND

Most products that are sold to end users, such as consumers and corporations, are not purchased directly from the manufacturers of the products, but rather from distributors, retailers, and other resellers of the products. A manufacturer thus sells a product to a distributor or a retailer, who in turn resells the product to an end user. As such, the distributor or retailer is referred to as a reseller.

There can be a tension between the manufacturer of a product and the reseller of the product, in terms of the number of the product that the reseller should purchase from the manufacturer each week to have on-hand to sell to end users. The manufacturer may prefer for the reseller to purchase a given number of the product each week, both to ensure that the reseller has sufficient stock on hand to sell to end users, and also to ensure that the number of the product that the manufacturer makes each week has ready buyers in the form of the resellers. By comparison, a reseller may prefer to stock lower numbers of a product, still sufficient to have on-hand stock to sell to end users, but not so much as to have too large of an existing inventory of the product, since the product may drop in price at a later point in time.

### BRIEF SUMMARY

A method of an embodiment of the present invention determines a minimum recommended supply line (RSL) and a maximum RSL for a product during a period of time. The minimum RSL is based on a minimum number of the product that a party is recommended to have in inventory for the period of time. The maximum RSL is based on a maximum number of the product that the party is recommended to have in inventory for the period of time. A computing device determines that the party has purchased within the period of time a number of the product equal to or greater than the minimum RSL minus a number of the product already in inventory at the party at a beginning of the period of time. In response, the computing device determines a price-protected number of the product as a smaller of the maximum RSL and a number of the product in inventory at the party at an end of the period of time. The computing device then determines a rebate amount owed to the party as equal to the price-protected number of the product multiplied by a decrease in price of the product from the period of time to a next period of time, and credits an account of the party by the rebate amount.

In a method of another embodiment of the invention, a computing device displays a minimum RSL and a maximum RSL for a product during a period of time. A party, via the computing device, purchases a number of the product within the period of time. Where the number of the product the party has purchased within the period of time is equal to or greater than the minimum RSL minus a number of the product already in inventory at the party at a beginning of the period of time, the party receives via the computing device a credit equal to a rebate amount owed to the party. The rebate amount is equal to a price-protected number of the product multiplied by a decrease in price of the product from the period of time to a next period of time. The price-protected number is equal to a smaller of the maximum RSL and a number of the product in inventory at the party at an end of the period of time.

A computing system of an embodiment of the invention includes a first component and a second component that are both implemented by the hardware. The first component is to determine a minimum RSL and a maximum RSL for a product during a period of time. The second component is to determine a rebate amount owed to the party. The rebate amount is equal to a price-protected number of the product multiplied by a decrease in price of the product from the period of time to a next period of time. The price-protected number of the product is equal to a smaller of the maximum RSL and a number of the product in inventory at the party at an end of the period of time. An account of the party is credited by the rebate amount where the party has purchased within the period of time a number of the product equal to or greater than the minimum RSL minus a number of the product already in inventory at the party at a beginning of the period of time.

A computer program product of an embodiment of the invention includes a computer-readable storage medium having computer-readable program code embodied therein. The computer-readable program code includes computer-readable program code to determine a minimum RSL and a maximum RSL for a product during a period of time. The computer-readable program code further includes computer-readable program code to determine a rebate amount owed to the party. The rebate amount is equal to a price-protected number of the product multiplied by a decrease in price of the product from the period of time to a next period of time. The price-protected number of the product is equal to a smaller of the maximum RSL and a number of the product in inventory at the party at an end of the period of time. An account of the party is credited by the rebate amount where the party has purchased within the period of time a number of the product equal to or greater than the minimum RSL minus a number of the product already in inventory at the party at a beginning of the period of time.

### BRIEF DESCRIPTION OF SEVERAL VIEWS OF THE DRAWINGS

The drawings referenced herein form a part of the specification. Features shown in the drawing are meant as illustrative of only some exemplary embodiments of the invention, and not of all embodiments of the invention, unless otherwise explicitly indicated, and implications to the contrary are otherwise not to be made.

FIG. 1 is a flowchart of a method from the perspective of a manufacturer or another (first) party, according to an embodiment of the present invention.

FIG. 2 is a flowchart of a method from the perspective of a reseller or another (second) party, according to an embodiment of the present invention.

FIG. 3 is a diagram of an exemplary system, according to an embodiment of the present invention.

FIG. 4 is a diagram depicting exemplary operation of a price-protection approach using a minimum recommended supply line (RSL) and a maximum RSL, according to an embodiment of the present invention.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the embodiment of the invention is defined only by the appended claims.

As noted in the background, there can be a disagreement between the manufacturer of a product and the reseller of the product, in terms of the number of the product that the reseller should purchase from the manufacturer each week to have on-hand to sell to end users. The manufacturer of the product may want the reseller to purchase a greater number of the product each week than the reseller wants to purchase, so that the manufacturer has a ready buyer (in the form of the reseller) for the number of the product it makes each week. By comparison, the reseller may prefer to stock a lower number of the product, so as not to have too large of an existing inventory of the product, because the product may drop in price at a later point in time.

A solution to this problem is to have a price-protection contract between the manufacturer and the reseller. In a price-protection contract, the manufacturer provides the reseller with a rebate between the current price of a product and the higher price(s) of the product at which the reseller actually purchased its inventory of the product, over a given period of time. The reseller is therefore provided an incentive to stock sufficient inventory of the product, without having to worry that the price of the product will drop at a later point in time. While the manufacturer of the product is ensured a more stable supply line for the product that it makes, the manufacturer nevertheless is exposed to greater supply chain costs in the form of the price-protection rebates.

Therefore, the inventors have developed a novel approach to price-protection contracts. A recommended supply line (RSL) range is determined. This range includes a minimum RSL and a maximum RSL for a product during a given period of time, such as on a week-to-week basis. The minimum RSL is based on the minimum number of the product that the reseller is recommended to have in inventory for the period of time, whereas the maximum RSL is based on the maximum number of the product that the reseller is recommended to have in inventory for the period of time. More specifically, the minimum and the maximum RSL's also account for open orders of the product that the reseller has placed with the manufacturer, but which have not been received into inventory yet. This can occur when the product of such orders are en route, or if the product is backordered with the manufacturer. If the reseller purchases within the period of time a number of the product such that the reseller's inventory of the product is increased to at least the minimum RSL, the reseller is later given a rebate for any remaining number of the product at the end of the period of time that is no greater than the maximum RSL.

This novel approach to price-protection contracts provides the manufacturer and the reseller with better precision in managing a supply line of a product The reseller is given a rebate so long as it purchases a number of the product that renders the reseller as having at least the minimum RSL within inventory. As such, the reseller is provided with more flexibility in determining how many of the product it should purchase for a given period of time. By comparison, the manufacturer just has to provide a rebate for the number of the product that remains in the reseller's inventory that is no greater than the maximum RSL. As such, the manufacturer is better able to manage its costs, because the number of the product on which basis the rebate is determined has an upper bound, and is not unlimited. Still other advantages, aspects, and embodiments of the invention will be recognized by reading the remainder of the detailed description, and by referring to the accompanying drawings.

Embodiments of the present invention can provide two outputs in particular. The first output is a purchase order that the reseller should place with the manufacturer, based on the minimum and maximum RSL's. The second output is a report that is provided every time period. The report details the price-protected number of the product in inventory at the party, and the price-protection rebate for which the party has qualified.

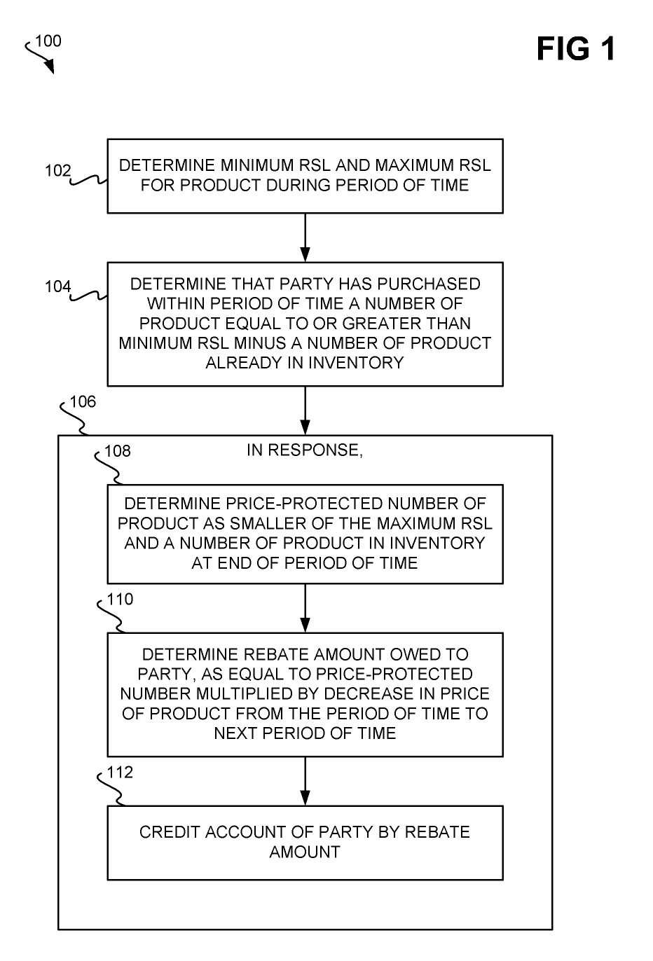

FIG. 1 shows a method 100, according to an embodiment of the invention. The minimum RSL and the maximum RSL for a product during a period of time is determined (102), which can include the manufacturer, for instance, setting the minimum and the maximum RSL's. The product may be a computer or a piece of computing equipment, for instance. A number of the product is defined herein as a number of instances of the same product. For example, twenty-five of a product having been purchased means that twenty-five of the same product have been purchased. The period of time may be a week, or another period of time. Once determined, the minimum RSL and the maximum RSL may be stored within a database implemented on a storage device, like a hard disk drive or a collection of hard disk drives organized as a storage-area network (SAN).

The minimum RSL and the maximum RSL can be determined in a variety of different ways, some examples of which are now provided, although embodiments of the invention are not limited to these examples. The minimum and the maximum RSL's may be determined by using a historical analysis approach that looks at numbers of the product that a party, such as a reseller, has in inventory during prior periods of time. As such, the minimum RSL may be the number of the product in inventory at the party during a first given period of time, and the maximum RSL may be the number of the product in inventory at the party during a second and different given period of time.

The minimum and the maximum RSL's may also be determined by first determining an optimal RSL for the product, and then determining the minimum RSL as a first percentage of the optimal RSL and the maximum RSL as a second percentage of the optimal RSL greater than the first percentage. The optimal RSL is the number of the product that the manufacturer believes the party should have in inventory during the period of time, based on any of a number of different factors, such as expected demand of the product from end purchasers, the number of the product that the manufacturer can make during the period of time, and so on. To provide flexibility to the optimal RSL, it is multiplied by two percentages to achieve a range bounded by the minimum RSL and by the maximum RSL.

The minimum and the maximum RSL's may also be determined based on an expected aged inventory of the product at the party during the period of time. The expected aged inventory of the product is the number of the product that the manufacturer believes will probably not sell to end purchasers during the period of time, but which the party (e.g., the reseller) should nevertheless stock just in case it does. The expected aged inventory thus is based on a forecast by the party for the product, and the distribution of aged inventory that the party is currently holding in stock. The age for each unit of the product is tracked at the party, and is equal to the length of time, such as the number of days, since the unit of the product was purchased. The minimal RSL is then determined as a first percentage of the expected aged inventory, and the maximum RSL is determined as a second percentage of the expected aged inventory greater than the first percentage.

The method 100 determines that a party, such as a reseller, has purchased within the period of time a number of the product equal to or greater than the minimum RSL minus a number of the product already in inventory at the beginning of the period of time (104). That is, the method 100 determines that the party has purchased a sufficient number of the product from the manufacturer so that the resulting number of the product that the party has or will have in inventory is at least equal to the minimum RSL, where the existing number of the product that the party already has in inventory is taken into account. Part 104 can include a computing device, such as a computer, looking up the number of the product that the party has purchased within the period of time in a database implemented on a storage device, looking up the number of the product already in inventory at the party at the beginning of the period of time in the database, and looking up the minimum RSL in the database.

The number of the product that a party already has in inventory at the beginning of the period of time can additively include one or more of the following. First, this number can include the number of the product that the party currently has on-hand at the beginning of the period of time, such as the number of the product at the warehouse(s) and/or at the retail store(s) of the party. Second, this number can include the number of the product that is currently in transit to the party (e.g., from the manufacturer) at the beginning of the period of time, and which the party has ordered or purchased. Third, this number can include the number of the product that the party has already (i.e., previously) ordered, but that is on backorder at the manufacturer at the beginning of the period of time.

In response to determining that the party has purchased a number of the product within the period of time equal to or greater than the minimum RSL minus the number of the product already in inventory at the party, the method 100 performs the following (106). First, the method 100 determines a price-protected number of the product, as a smaller of the maximum RSL and a number of the product in inventory at the end of the period of time (108). Part 108 can include a computing device calculating or looking up the number of the product in inventory at the party at the end of the period of time within a database implemented on the storage device, and looking up the maximum RSL within the database.

If the number of the product in inventory at the party at the end of the period of time is looked up, then this means that this number is not calculated from other numbers. By comparison, if the number of the product in inventory at the party at the end of the period is calculated, then this number from other numbers. For instance, the number of the product in inventory at the party at the end of the period may be calculated as being equal to a sum of the number of the product that the party has purchased within the period of time and the number of the product already in inventory at the party at the beginning of the period of time, minus the number of the product sold by the party during the period of time.

The method 100 then determines the rebate amount owed to the party, as equal to the price-protected number multiplied by a decrease in the price of the product from the period of time to the next period of time (110). For instance, if the price of the product decreases from $X to $(X−Y) from the (current) period of time to the next period of time, then the rebate amount owed to the party is equal to $Y times the price-protected number. Part 110 can include a computing device looking up a price of the product at the beginning of the period of time within a database implemented on a storage device, and looking up a price of the product at the beginning of the next period of time within the database. The next period of time is desirably the period of time that occurs immediately after the current period of time.

The method 100 concludes by crediting an account of the party by the rebate amount that has been determined (112). The method 100 has been described from the point of view of the manufacturer, such as an original equipment manufacturer (OEM), or another (first) party, that sells a product to a reseller, such as a distributor, a retailer, or another (second) party for reselling the product to an end purchaser like a consumer or an organization. However, the price-protection approach of the method 100 can also be described from the point of view of the second party that resells the product to an end purchaser, as is now presented.

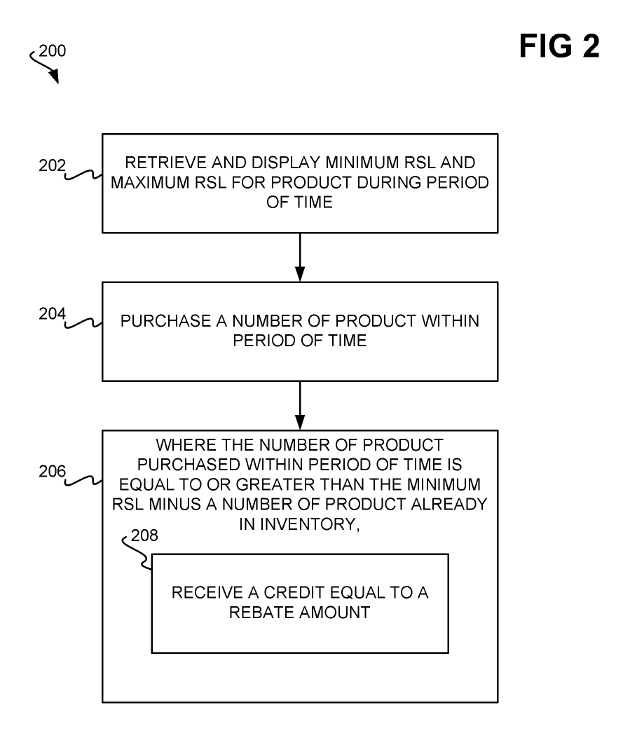

FIG. 2 shows such a method 200, according to another embodiment of the invention. A computing device at a party like a reseller is used to retrieve and display the minimum RSL and the maximum RSL for a product during a period of time (202). Part 202 can thus include the computing device looking up the minimum and the maximum RSL's within a database implemented on a storage device.

The party purchases, via or using the computing device, a number of the product within the period of time (204). Where the number of the product purchased within the period of time is equal to or greater than the minimum RSL minus a number of the product already in inventory at the beginning of the period of time (206), the method 200 performs the following. In particular, the party receives, via the computing device, a credit equal to a rebate amount owed to the party (208).

The rebate amount is equal to a price-protected number of the product multiplied by a decrease in price of the product from the (current) period of time to a next period of time. The price-protected number is equal to the maximum RSL or the number of the product in inventory at the party at the end of the period of time, whichever is smaller. The method 200 thus describes the price-protection approach from the point of view of the reseller, as compared to from the point of view of the manufacturer as is the case with the method 100.

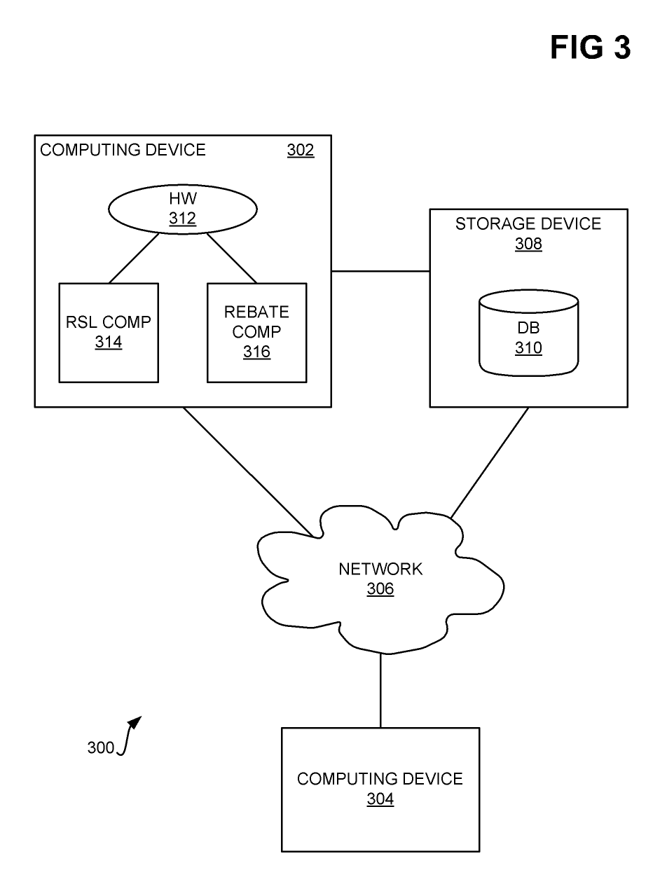

FIG. 3 shows an exemplary system 300 in which the price-protection approach that has been described can be implemented, according to an embodiment of the invention. The system 300 includes computing devices 302 and 304 communicatively interconnected via a network 306. The system 300 also includes a storage device 308. The computing devices 302 and 304 may in actuality each be more than one computing device, such as a desktop or a laptop computer, a server computing device, a client computing device, and/or another type of computer or computing device. The network 306 can be or include a local-area network (LAN), a wide-area network (WAN), an intranet, an extranet, the Internet, and/or another type of network.

The computing device 302 and the storage device 308 are those of the manufacturer, whereas the computing device 304 is that of the reseller. The storage device 308 may be a storage-area network (SAN) having a number of hard disk drives, such that the storage device 308 is directly communicatively connected to the network 306 and is external to the computing device 302, as is depicted in FIG. 3. Alternatively, the storage device 308 may be part of the computing device 302, or another computing device of the manufacturer. The storage device 308 implements or stores a database 310.

The computing device 302 includes at least hardware 312, such as one or more processors, volatile memory, and/or local storage devices, among other types of hardware commonly found within a computer. The hardware 312 implements an RSL component 314 and a rebate component 316. For example, the components 314 and 316 may be implemented as computer-readable program code that is executed using at least some of the hardware 312.

The RSL component 314 determines a minimum RSL and a maximum RSL for a product during a period of time. By comparison, the rebate component 316 determines the rebate amount owed to the reseller. As described above, the rebate amount is equal to a price-protected number of the product multiplied by a decrease in price of the product from the (current) period of time to the next period of time, where the price-protected number is equal to the smaller of the maximum RSL and the number of the product in inventory at the reseller at the end of the period of time. The components 314 and 316 thus implement the method 100 on the computing device 302.

The computing device 304 also includes hardware and software. However, the hardware and software of the computing device 304 are not explicitly called out in FIG. 3. The computing device 304 performs the method 200. As such, the hardware and the software of the computing device 304 implement the method 200 on the computing device 304.

The database 310 stores the minimum RSL and the maximum RSL that are determined. The database 310 also stores information regarding the product in relation to the reseller. For instance, this information can include the number of the product that the reseller has purchased within the given period of time in question, the number of the product already in inventory at the reseller at the beginning of this period of time, as well as the number of the product in inventory at the reseller at the end of this period of time.

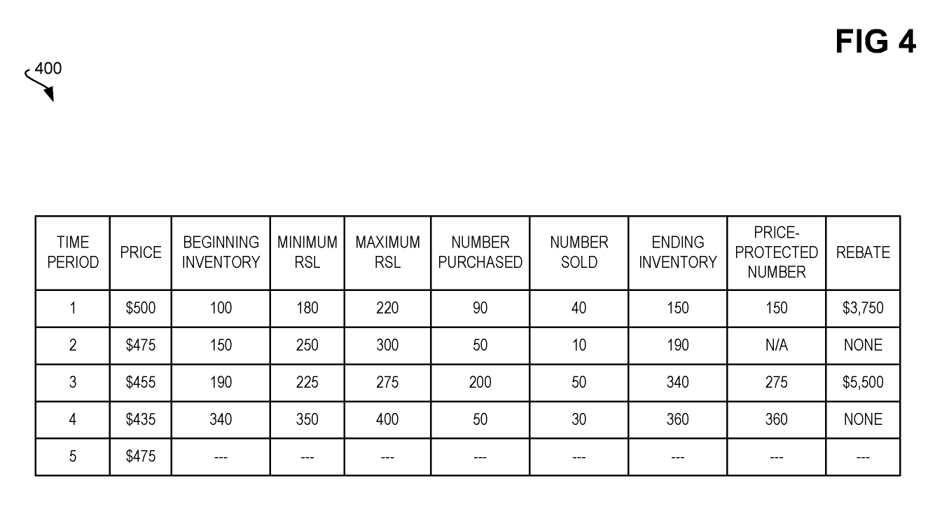

In conclusion, FIG. 4 shows a table 400, in relation to which representative operation of the price-protection approach that has been presented is described, according to an embodiment of the invention. The first four rows of the table 400 correspond to four consecutive time periods. In each time period, a product has been set at a given price, the reseller has a beginning inventory of the product, a minimum RSL and a maximum RSL have been set by the manufacturer, a number of the product has been purchased by the reseller, the reseller has an ending inventory of the product, a price-protected number may be determined, and a rebate may be credited to the reseller. The last row of the table 400 corresponds to a fifth consecutive time period, in which just the price of the product during this time period is shown.

In the first time period, the price of the product is $500, and the reseller has an inventory at the beginning of the first time period of 100 of the product. The manufacturer has set the minimum and the maximum RSL's to 180 and 220, respectively. The reseller has purchased 90 of the product during the first time period, at the price of $500 each. As a result of selling 40 of the product, the reseller has an inventory of 150 of the product at the end of the first time period. Pursuant to the method 100, the reseller is owed a rebate amount. This is because the party has purchased 90 of the product during the first time period, which is greater than the minimum RSL of 180 minus the beginning inventory of 100, or 80. The price-protected number of the product is 150, which is the smaller of the ending inventory of 150 and the maximum RSL of 220. Because the price drops from $500 to $475 from the first time period to the second time period, the rebate amount is equal to 150 times ($500 minus $475), or $3,750. (It is noted that in general, the price of the product does not necessarily have to change between two consecutive time periods.)

In the second time period, the price of the product is $475, and the reseller has an inventory at the beginning of the second time period of 150 of the product. The manufacturer has set the minimum and the maximum RSL's to 150 and 250, respectively. The reseller has purchased just 20 of the product during the second time period, at the price of $475 each. As a result of selling 10 of the product, the reseller has an inventory of 190 of the product at the end of the second time period. Pursuant to the method 100, the reseller is not owed a rebate amount. This is because the party has purchased 50 of the product during the second time period, which is not greater than the minimum RSL of 250 minus the beginning inventory of 150, or 100. Note that the reseller is not owed a rebate amount, even though the price drops from $475 to $455 from the first time period to the second time period. A price-protected number may not be calculated in the second time period.

In the third time period, the price of the product is $455, and the reseller has an inventory at the beginning of the third time period of 190 of the product. The manufacturer has set the minimum and the maximum RSL's to 225 and 275, respectively. The reseller has purchased 200 of the product during the third time period, at the price of $455 each. As a result of selling 50 of the product, the reseller has an inventory of 340 of the product at the end of the third time period. Pursuant to the method 100, the reseller is owed a rebate amount. This is because the party has purchased 200 of the product during the third time period, which is greater than the minimum RSL of 225 minus the beginning inventory of 190, or 35. The price-protected number of the product of the product is 275, which is the smaller of the ending inventory of 340 and the maximum RSL of 275; as such, the reseller is not price-protected for 65 of the product (i.e., the ending inventory of 340 minus the maximum RSL 75). Because the price drops from $455 to $35 from the third time period to the fourth time period, the rebate amount is equal to 275 times ($455 minus $435), or $5,500.

In the fourth time period, the price of the product is $435, and the reseller has an inventory at the beginning of the fourth time period of 340 of the product. The manufacturer has set the minimum and the maximum RSL's to 350 and 400, respectively. The reseller has purchased 50 of the product during the fourth time period, at the price of $435 each. As a result of selling 30 of the product, the reseller has an inventory of 360 of the product at the end of the fourth time period. Pursuant to the method 100, the reseller should be owed a rebate. This is because the party has purchased 50 of the product during the fourth time period, which is greater than the minimum RSL of 350 minus the beginning inventory of 340, or 10. The price-protected amount is 360, which is the smaller of the ending inventory of 360 and the maximum RSL of 400. However, the reseller is not in actuality owed a rebate. This is because the price of the product increases from $435 in the fourth period to $475 in the fifth period.

Aspects of the present invention have been described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented on computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented on special purpose hardware-based systems that perform the specified functions or acts, or combinations of special purpose hardware and computer instructions.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. As such and therefore, it is manifestly intended that this invention be limited only by the claims and equivalents thereof.

We claim:

1. A method comprising:
determining a minimum recommended supply line (RSL) and a maximum RSL for a product during a period of time, the minimum RSL based on a minimum number of the product that a party is recommended to have in inventory for the period of time, the maximum RSL based on a maximum number of the product that the party is recommended to have in inventory for the period of time;
in response to determining, by a computing device, that the party has purchased within the period of time a number of the product equal to or greater than the minimum RSL minus a number of the product already in inventory at the party at a beginning of the period of time,
determining, by the computing device, a price-protected number of the product as a smaller of the maximum RSL and a number of the product in inventory at the party at an end of the period of time;
determining, by the computing device, a rebate amount owed to the party as equal to the price-protected number of the product multiplied by a decrease in price of the product from the period of time to a next period of time; and,
crediting an account of the party by the rebate amount.

2. The method of claim 1,
wherein determining the minimum RSL and the maximum RSL during the period of time comprises storing the minimum RSL and the maximum RSL within a database implemented on a storage device, by the computing device,
wherein determining that the party has purchased within the period of time the number of product equal to or greater than the minimum RSL minus the number of the product already in inventory at the party at the beginning of the period of time comprises:
looking up the number of the product that the party has purchased within the period of time, within the database implemented on the storage device, by the computing device;
looking up the number of the product already in inventory at the party at the beginning of the period of time, within the database implemented on the storage device, by the computing device; and,
looking up the minimum RSL within the database implemented on the storage device, by the computing device,
wherein determining the price-protected number of the product comprises:
looking up the number of the product in inventory at the party at the end of the period of time, within the database implemented on the storage device, by the computing device; and,
looking up the maximum RSL within database implemented on the storage device, by the computing device,
and wherein determining the rebate amount owed to the party comprises:
looking up a price of the product at the beginning of the period of time, within the database implemented on the storage device, by the computing device; and,
looking up a price of the product at a beginning of the next period of time, within the database implemented on the storage device, by the computing device.

3. The method of claim 1, wherein the number of the product already in inventory at the party at the beginning of the period of time comprises one or more of:
a number of the product that the party currently has on-hand at the beginning of the period of time;
a number of the product in transit to the party at the beginning of the period of time; and,
a number of the product that the party has ordered but that is on backorder at the beginning of the period of time.

4. The method of claim 1, wherein the number of the product in inventory at the party at the end of the period of time is looked up within a database implemented on a storage device, and is not calculated.

5. The method of claim 1, wherein the number of the product in inventory at the party at the end of the period of time is calculated as equal to the number of the product that the party has purchased within the period of time, plus the number of the product already in inventory at the party at the beginning of the period of time, minus a number of the product sold by the party during the period of time.

6. The method of claim 1, wherein determining the minimum RSL and the maximum RSL for the product comprises:
determining the minimum RSL as a number of the product in inventory at the party during a first period of time; and,
determining the maximum RSL as a number of the product in inventory at the party during a second period of time different than the first period of time.

7. The method of claim 1, wherein determining the minimum RSL and the maximum RSL for the product comprises:
determining an optimal RSL;
determining the minimum RSL as equal to a first percentage of the optimal RSL; and,
determining the maximum RSL as equal to a second percentage of the optimal RSL, the second percentage different than the first percentage.

8. The method of claim 1, wherein determining the minimum RSL and the maximum RSL for the product comprises:
determining an expected aged inventory of the product at the party during the period of time;
determining the minimum RSL as equal to a first percentage of the expected aged inventory; and,
determining the maximum RSL as equal to a second percentage of the expected aged inventory, the second percentage different than the first percentage.

9. A method comprising:
displaying, by a computing device, a minimum recommended supply line (RSL) and a maximum RSL for a product during a period of time, the minimum RSL based on a minimum number of the product that a party is recommended to have in inventory for the period of time, the maximum RSL based on a maximum number of the product that the party is recommended to have in inventory for the period of time;
purchasing, by the party via the computing device, a number of the product within the period of time;
where the number of the product the party has purchased within the period of time is equal to or greater than the minimum RSL minus a number of the product already in inventory at the party at a beginning of the period of time,
receiving, by the party via the computing device, a credit equal to a rebate amount owed to the party, the rebate amount equal to a price-protected number of the product multiplied by a decrease in price of the product from the period of time to a next period of time, the price-protected number equal to a smaller of the maximum RSL and a number of the product in inventory at the party at an end of the period of time.

10. The method of claim 9, wherein display the minimum RSL and the maximum RSL comprises looking up the minimum RSL and the maximum RSL for the product, by the computing device within a database implemented on a storage device.

11. The method of claim 9, wherein the number of the product already in inventory at the party at the beginning of the period of time comprises one or more of:
a number of the product that the party currently has on-hand at the beginning of the period of time;
a number of the product in transit to the party at the beginning of the period of time; and,
a number of the product that the party has ordered but that is on backorder at the beginning of the period of time.

12. The method of claim 9, wherein the number of the product in inventory at the party at the end of the period of time is looked up within a database implemented on a storage device, and is not calculated.

13. The method of claim 9, wherein the number of the product in inventory at the party at the end of the period of time is calculated as equal to the number of the product that the party has purchased within the period of time, plus the number of the product already in inventory at the party at the beginning of the period of time, minus a number of the product sold by the party during the period of time.

14. A computing system comprising:
hardware;
a first component implemented by the hardware to determine a minimum recommended supply line (RSL) and a maximum RSL for a product during a period of time, the minimum RSL based on a minimum number of the product that a party is recommended to have in inventory for the period of time, the maximum RSL based on a maximum number of the product that the party is recommended to have in inventory for the period of time; and,
a second component implemented by the hardware to determine a rebate amount owed to the party, the rebate amount equal to a price-protected number of the product multiplied by a decrease in price of the product from the period of time to a next period of time, the price-protected number of the product equal to a smaller of the maximum RSL and a number of the product in inventory at the party at an end of the period of time,
wherein an account of the party is credited by the rebate amount where the party has purchased within the period of time a number of the product equal to or greater than the minimum RSL minus a number of the product already in inventory at the party at a beginning of the period of time.

15. The computing system of claim 14, further comprising a storage device to implement a database, the database to store the minimum RSL, the maximum RSL, the number of the product that the party has purchased within the period of time, the number of the product already in inventory at the party at the beginning of the period of time, and the number of the product in inventory at the party at the end of the period of time.

16. The computing system of claim 14, wherein the number of the product already in inventory at the party at the beginning of the period of time comprises one or more of:
a number of the product that the party currently has on-hand at the beginning of the period of time;
a number of the product in transit to the party at the beginning of the period of time; and,
a number of the product that the party has ordered but that is on backorder at the beginning of the period of time.

17. The computing system of claim 14, wherein the number of the product in inventory at the party at the end of the period of time is looked up within a database implemented on a storage device, and is not calculated.

18. A computer program product comprising:
a computer-readable storage medium having computer-readable program code embodied therein, the computer-readable program code comprising:
computer-readable program code to determine a minimum recommended supply line (RSL) and a maximum RSL for a product during a period of time, the minimum RSL based on a minimum number of the product that a party is recommended to have in inventory for the period of time, the maximum RSL based on a maximum number of the product that the party is recommended to have in inventory for the period of time; and,
computer-readable program code to determine a rebate amount owed to the party, the rebate amount equal to a price-protected number of the product multiplied by a decrease in price of the product from the period of time to a next period of time, the price-protected number of the product equal to a smaller of the maximum RSL and a number of the product in inventory at the party at an end of the period of time,
wherein an account of the party is credited by the rebate amount where the party has purchased within the period of time a number of the product equal to or greater than the minimum RSL minus a number of the product already in inventory at the party at a beginning of the period of time.

19. The computer-readable program code of claim 18, wherein the number of the product already in inventory at the party at the beginning of the period of time comprises one or more of:
a number of the product that the party currently has on-hand at the beginning of the period of time;
a number of the product in transit to the party at the beginning of the period of time; and,
a number of the product that the party has ordered but that is on backorder at the beginning of the period of time.

20. The computer-readable program code of claim 18, wherein the number of the product in inventory at the party at the end of the period of time is looked up within a database implemented on a storage device, and is not calculated.
